(19) United States
(12) Patent Application Publication
(10) Pub. No.: US 2026/0276006 A1
(43) Pub. Date: Sep. 17, 2026

(54) BOX FAN SURFACE-MOUNT DEVICE

(71) Applicant: James Montgomery, Yonkers, NY (US)

(72) Inventor: James Montgomery, Yonkers, NY (US)

(21) Appl. No.: 19/547,785

(22) Filed: Feb. 24, 2026

Related U.S. Application Data
(60) Provisional application No. 63/771,052, filed on Mar. 13, 2025.

(51) Int. Cl. F04D 29/64; F16M 13/02

(52) U.S. Cl. CPC F04D 29/646; F16M 13/02

(57) ABSTRACT

A box fan surface-mount device is provided. The device is comprised of a frame assembly that securely holds a box fan on various surfaces, including walls, ceilings, and corners. The frame assembly comprises at least two frame members connected by a horizontal frame arm, allowing adjustable width in a telescopic embodiment. Each frame member comprises vertical and horizontal members and further includes a cradle assembly with telescopic angled members that adjust to different fan depths and feature fasteners such as clips or magnets for retention. The cradle assemblies attach to the frame members via pivot points, enabling fan orientation adjustment, and may include locking mechanisms for stability. The device is also comprised of a mounting structure for secure attachment to surfaces using fasteners.

### CROSS-REFERENCE TO RELATED APPLICATION

The present application claims priority to, and the benefit of, U.S. Provisional Application No. 63/771,052, which was filed on Mar. 13, 2025, and is incorporated herein by reference in its entirety.

### FIELD OF THE INVENTION

The present invention relates generally to the field of box fans. More specifically, the present invention relates to a frame assembly that securely holds a box fan on various surfaces, including walls, ceilings, and corners. Accordingly, the present disclosure makes specific reference thereto. Nonetheless, it is to be appreciated that aspects of the present invention are also equally applicable to other like applications, devices, and methods of manufacture.

### BACKGROUND

Box fans are commonly used in both residential and commercial environments to facilitate air circulation, especially in settings where air conditioning is insufficient or unavailable. Despite their ubiquity, box fans often suffer from issues related to placement, stability, and effectiveness. Many users resort to placing box fans on tables, floors, countertops, or shelves, which may not provide an ideal airflow direction. These locations often result in suboptimal air distribution, limited reach, or blocked air pathways. Additionally, box fans placed in such locations are frequently unstable and prone to tipping or falling, presenting safety concerns and increasing the risk of damage to the fan or surrounding objects. Users may also experience frustration in having to frequently reposition or adjust the fan to target a specific area, which can be time-consuming and inefficient. In some instances, poor fan positioning may even lead to increased noise levels due to vibration or airflow obstruction. Further, inadequate mounting options can limit the practical integration of box fans into rooms with limited surface space. These shortcomings indicate a need for a more stable, adjustable, and space-efficient device to secure and utilize box fans effectively within indoor environments.

Therefore, there exists a long-felt need in the art for a box fan surface-mount device that provides a stable and secure mounting solution to prevent tipping or falling during operation. There also exists a long-felt need in the art for a box fan surface-mount device that enables flexible positioning on various surfaces, such as walls, ceilings, or corners, to optimize airflow direction. Moreover, there exists a long-felt need in the art for a box fan surface-mount device that reduces the need for constant manual adjustment and maximizes user convenience.

The subject matter disclosed and claimed herein, in one embodiment thereof, comprises a box fan surface-mount device. The device is comprised of a frame assembly that securely holds a box fan on various surfaces, including walls, ceilings, and corners. The frame assembly comprises at least two frame members connected by a horizontal frame arm, allowing adjustable width in a telescopic embodiment. Each frame member comprises vertical and horizontal members and further includes a cradle assembly with telescopic angled members that adjust to different fan depths and feature fasteners such as clips or magnets for retention. The cradle assemblies attach to the frame members via pivot points, enabling fan orientation adjustment, and may include locking mechanisms for stability. The device is also comprised of a mounting structure for secure attachment to surfaces using fasteners. A method of use comprises configuring the frame, fitting the cradle assemblies to the fan, securing the fan using fasteners, orienting the fan via pivot points, and mounting the device for effective directional airflow.

In this manner, the box fan surface-mount device of the present invention accomplishes all the foregoing objectives and provides a cradle-style frame assembly that secures a box fan. Further, the device allows for installation on walls, ceilings, or corner areas, thereby optimizing fan placement and improving airflow direction. The incorporation of pivoting cradle assemblies enables precise directional adjustments without dismounting the fan. In addition, the modular design supports fans of varying dimensions and shapes, while the secure locking features maintain the selected configuration during use. Through these integrated features, the box fan surface-mount device effectively addresses the critical needs for stability, adjustability, and spatial efficiency in box fan usage.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a box fan surface-mount device comprised of a frame assembly configured to cradle and retain a box fan on walls, ceilings, corners, or other surfaces. The frame assembly is comprised of a first frame member and a second frame member connected by at least one horizontal frame arm. The horizontal frame arm may be telescopic and include a locking mechanism to allow for adjustable width of the frame assembly.

Each frame member is comprised of a vertical member and a pair of horizontal members that may be parallel, angled, or non-parallel, depending on spatial or structural requirements. Each frame member is further comprised of at least one cradle assembly. Each cradle assembly is comprised of a vertical member and a pair of angled members that may be parallel, non-parallel, or angularly offset to accommodate various box fan shapes. The angled members may be telescopic and secured in length by a locking mechanism to fit different fan depths.

Each angled member may be comprised of at least one fastener configured to attach to and retain a box fan. Fasteners may include mechanical or magnetic components such as clips, hooks, or magnets and may be integrated into or extend from the angled members. The horizontal frame arm may also be comprised of fasteners located on a pair of horizontal members, which may be parallel, angled, or non-parallel to assist in center retention of the fan.

The cradle assembly may attach to the frame members via at least one pivot point, allowing adjustable movement to reposition the box fan for desired airflow. The pivot point may be a locking or adjustable joint such as a hinge, pin joint, or rotating bracket.

The device may be further comprised of at least one mounting structure, including brackets, plates, or grooves, enabling secure attachment to a surface using fasteners such as screws, bolts, or adhesive attachments. The mounting structure may be formed integrally with a supporting component and designed to distribute loads.

The device may also be comprised of at least one vibration-dampening element positioned between the cradle assembly and the fan to reduce vibration transmission and noise. Additionally, anti-slip elements may be positioned on the angled members, horizontal members, or fasteners to prevent fan displacement and enhance retention.

A method of using the device comprises providing the device, adjusting the frame width using the telescopic arm and locking mechanism, extending the angled members to fit fan depth, securing the fan using fasteners, adjusting the pivot point for airflow orientation, and mounting the device to a surface with appropriate fasteners.

Accordingly, the box fan surface-mount device of the present invention is particularly advantageous as it provides a cradle-style frame assembly that secures a box fan. Further, the device allows for installation on walls, ceilings, or corner areas, thereby optimizing fan placement and improving airflow direction. The incorporation of pivoting cradle assemblies enables precise directional adjustments without dismounting the fan. In addition, the modular design supports fans of varying dimensions and shapes, while the secure locking features maintain the selected configuration during use. Through these integrated features, the box fan surface-mount device effectively addresses the critical needs for stability, adjustability, and spatial efficiency in box fan usage. In this manner, the box fan surface-mount device overcomes the limitations of existing methods of using box fans known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a frame assembly of one potential embodiment of a box fan surface-mount device of the present invention in accordance with the disclosed architecture;

FIG. 2 illustrates a perspective view of one potential embodiment of a box fan surface-mount device of the present invention while securing a box fan in accordance with the disclosed architecture; and

FIG. 3 illustrates a flowchart of a method of using one potential embodiment of a box fan surface-mount device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a box fan surface-mount device that provides a stable and secure mounting solution to prevent tipping or falling during operation. There also exists a long-felt need in the art for a box fan surface-mount device that enables flexible positioning on various surfaces, such as walls, ceilings, or corners, to optimize airflow direction. Moreover, there exists a long-felt need in the art for a box fan surface-mount device that reduces the need for constant manual adjustment and maximizes user convenience.

The present invention, in one exemplary embodiment, is comprised of a box fan surface-mount device comprised of a frame assembly configured to cradle and secure a box fan on walls, ceilings, corners, or other surfaces. The frame assembly is comprised of a first frame member and a second frame member joined by at least one horizontal frame arm. The horizontal frame arm may be telescopic and incorporate a locking mechanism to enable width adjustment of the frame assembly.

Each frame member is comprised of a vertical member and a pair of horizontal members that may be parallel, angled, or non-parallel, based on spatial or structural requirements. Each frame member is further comprised of at least one cradle assembly. Each cradle assembly is comprised of a vertical member and a pair of angled members, which may be parallel, non-parallel, or angularly offset to accommodate various box fan geometries. The angled members may be telescopic and include a locking mechanism to allow adjustment to different fan depths.

Each angled member may be comprised of at least one fastener configured to secure a box fan. Fasteners may include mechanical or magnetic components such as clips, hooks, or magnets and may be embedded within or extend from the angled members. The horizontal frame arm may also be comprised of fasteners positioned along a pair of horizontal members, which may be parallel, angled, or non-parallel, to assist with center retention of the fan.

The cradle assembly may be attached to the frame members through at least one pivot point, allowing for repositioning of the box fan to achieve the desired airflow direction. The pivot point may be a locking or adjustable joint such as a hinge, pin joint, or rotating bracket.

The device may be further comprised of at least one mounting structure, such as a bracket, plate, or groove, for secure attachment to a surface using fasteners including screws, bolts, or adhesive elements. The mounting structure may be integrally formed with a supporting component and configured to distribute loads.

The device may also be comprised of at least one vibration-dampening element positioned between the cradle assembly and the box fan to reduce vibration transmission and noise. Anti-slip elements may also be included on the angled members, horizontal members, or fasteners to prevent displacement and improve retention of the box fan.

The method of using the device includes providing the device, adjusting the frame width through the telescopic arm and locking mechanism, extending the angled members to fit the fan depth, securing the fan with fasteners, orienting the fan using the pivot point, and attaching the device to a surface using mounting fasteners.

As a result, the box fan surface-mount device is advantageous in providing a cradle-style frame assembly for secure box fan placement. The device supports installation on walls, ceilings, or corner areas, enhancing fan positioning and airflow control. The pivoting cradle assemblies allow directional adjustment without removing the fan. The modular design accommodates fans of various shapes and sizes, while the locking mechanisms ensure configuration stability during operation. These features address key requirements for stability, adjustability, and spatial efficiency in box fan applications, overcoming the limitations of prior approaches.

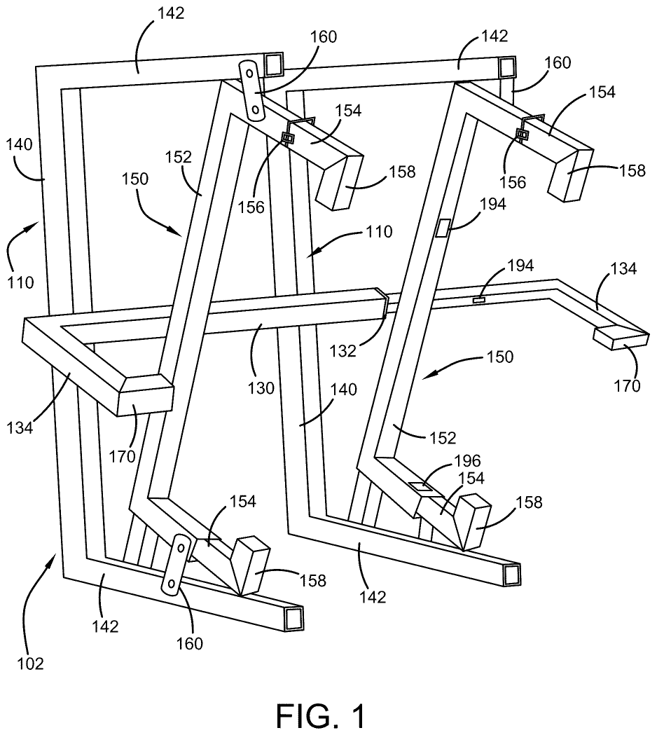

Referring initially to the drawings, FIG. 1 illustrates a perspective view of a frame assembly 102 of one potential embodiment of a box fan surface-mount device 100 of the present invention in accordance with the disclosed architecture. The box fan surface-mount device 100 is comprised of a device that cradles a box fan 10 on walls, ceilings, in the corners of any room, and/or other surfaces. The device 100 is comprised of a frame assembly 102. The frame assembly 102 is comprised of a first frame member 110 and a second frame member 120 connected by at least one horizontal frame arm 130. The frame members 110, 120 are preferably, but are not limited to, parallel. The arm 130 may be telescopic in one embodiment to allow the entire frame assembly 102 to adjust in width. In this embodiment, the length of the arm 130 can be secured by at least one locking mechanism 132, such as, but not limited to, a twist-lock collar, detent pin, threaded knob, friction-based clamp, or spring-loaded latch.

Each frame assembly 102 is comprised of a vertical member 140 and preferably a pair of generally parallel horizontal members 142. The members 142 may form any angle relative to any axis of the vertical member 140 in different embodiments. While the members 142 are preferably parallel to each other, they may alternatively be non-parallel or angled in relation to each other or to the vertical member 140, depending on structural or spatial requirements. Each frame member 110, 120 is further comprised of at least one cradle assembly 150. The cradle assembly 150 is comprised of a vertical member 152 and a pair of angled members 154 that are preferably, but not limited to, generally parallel. In alternate configurations, the angled members 154 may be non-parallel or angularly offset to accommodate non-standard box fan 10 shapes or mounting scenarios.

Each member 154 may be telescopic in one embodiment to allow the depth of the member 154 to increase or decrease to accommodate various box fan 10 depths. In a telescopic embodiment, the length of the members 154 can be secured by at least one locking mechanism 156, such as, but not limited to, a detent button, cam lock, threaded collar, spring-loaded pin, or lever-activated latch.

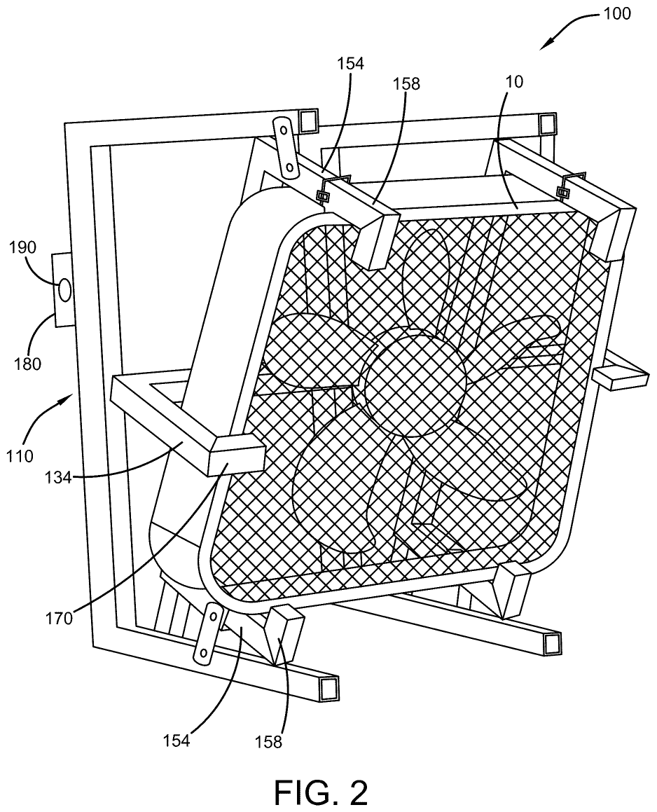

Each member 154 may also be comprised of at least one fastener 158 that allows the member to attach to and retain a box fan 10, as seen in FIG. 2. The fastener 158 may include, but is not limited to, a magnet, clip, tab, angled tab, hook, or other mechanical or magnetic securing feature configured to engage with structural elements of a box fan 10. The fastener 158 may be integrated into the surface of the member 154 in one embodiment or may extended outwards from the member 154. In one embodiment, the horizontal frame arm 130 is also comprised of a similar fastener 170 that is positioned on a pair of generally parallel horizontal members 134 of the arm 130. In certain embodiments, the horizontal members 134 may alternatively be non-parallel or angled relative to each other or the frame arm 130, depending on required clearance, orientation, or fan geometry. The fasteners 170 may assist in center retention of the fan 10 and may be symmetrically or asymmetrically positioned based on structural design.

In one embodiment, the vertical member 152 and/or angled members 154 attach to the horizontal members 142 of each frame member 110, 120 via at least one pivot point 160, such as, but not limited to, a hinge, pin joint, rotating bracket, or ball joint. The pivot point 160 may allow for upward, downward, and/or side-to-side movement of the cradle assembly 150 relative to the frame members 110, 120 to allow the box fan 10 to be repositioned as necessary toward the desired airflow direction. The pivot point 160 may be any type of locking pivot point, such as, but not limited to, a ratcheting hinge, indexed detent joint, friction hinge, adjustable torque hinge, quick-release clamp, or locking pin assembly.

Any part of the device 100 may further be comprised of at least one mounting structure 180 (as seen in FIG. 2), such as, but not limited to, a bracket, flange, plate, groove, channel, or recess that allows the device 100 to be mounted to a wall or other surface via at least one fastener 190, such as, but not limited to, a screw, bolt, anchor, nail, or adhesive attachment. The mounting structure 180 may be formed integrally with or affixed to a supporting component such as the vertical member 140 and may be arranged to distribute mounting loads across multiple contact points. The fastener 190 may be selected according to the surface composition and desired holding capacity, allowing for secure, semi-permanent, or adjustable installation.

In one embodiment, the device 100 is further comprised of at least one vibration-dampening element 194, as seen in FIG. 1. The vibration-dampening element 194 may be positioned between the cradle assembly 150 and the box fan 10, and may be comprised of a material such as rubber, foam, silicone, or other compressible or energy-absorbing material. The vibration-dampening element 194 may reduce transmission of operational vibrations to the mounting surface and minimize noise during use.

In another embodiment, the device 100 is further comprised of at least one anti-slip element 196 positioned along the surface of any angled member 154, horizontal member 134, and/or fastener 158, 170. The anti-slip element 196 may be comprised of high-friction material such as, but not limited to, textured rubber, silicone pads, or abrasive coatings and may prevent unintentional displacement of the box fan 10 when inserted into the cradle assembly 150.

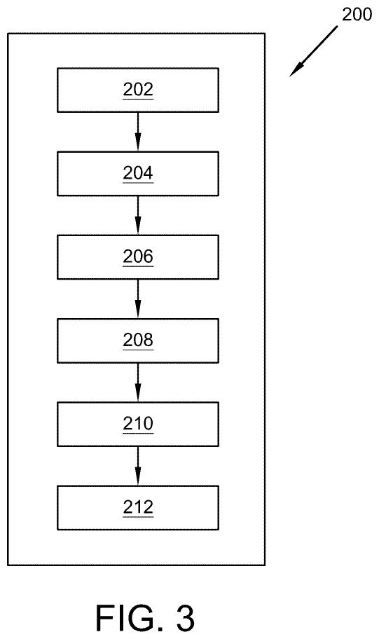

The present invention is also comprised of a method of using 200 the device 100, as seen in FIG. 3. First, a device 100 is provided comprised of a frame assembly 102, wherein the frame assembly 102 is comprised of at least a first frame member 110, a second frame member 120, at least one horizontal frame arm 130, and at least one cradle assembly 150 [Step 202]. In one embodiment, the width of the frame assembly 102 can be adjusted by telescoping the arm 130 and securing the length via at least one locking mechanism 132 [Step 204]. Next, the cradle assembly 150 can be adjusted to fit the depth of the box fan 10 by extending the telescopic angled members 154 and securing the length via at least one locking mechanism 156 [Step 206]. Following this, the box fan 10 can be inserted into the cradle assembly 150 such that the fasteners 158 and 170 retain the fan securely in position [Step 208]. Then, the pivot point 160 can be adjusted to orient the box fan 10 in the desired direction and can be locked in place in an embodiment with a locking pivot point 160 [Step 210]. Finally, the device 100 can be mounted to a surface using the mounting structure 180 and at least one fastener 190, completing the setup for directional airflow as desired [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “box fan surface-mount device” and “device” are interchangeable and refer to the box fan surface-mount device 100 of the present invention.

Notwithstanding the foregoing, the box fan surface-mount device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the box fan surface-mount device 100 as shown in the FIGS. are for illustrative purposes only, and that many other sizes and shapes of the box fan surface-mount device 100 are well within the scope of the present disclosure. Although the dimensions of the box fan surface-mount device 100 are important design parameters for user convenience, the box fan surface-mount device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A box fan surface-mount device comprising:
a frame assembly comprising a first frame member and a second frame member connected by a horizontal frame arm;
wherein the first frame member is comprised of a first vertical member and a first pair of horizontal members;
wherein the second frame member is comprised of a second vertical member and a second pair of horizontal members;
wherein the first frame member is comprised of a first cradle assembly configured to receive a box fan; and
further wherein the second frame member is comprised of a second cradle assembly configured to receive the box fan.

2. The box fan surface-mount device of claim 1, wherein the first cradle assembly is comprised of a first pair of angled members.

3. The box fan surface-mount device of claim 2, wherein the first pair of angled members are telescopic.

4. The box fan surface-mount device of claim 1, wherein the second cradle assembly is comprised of a second pair of angled members.

5. The box fan surface-mount device of claim 4, wherein the second pair of angled members are telescopic.

6. The box fan surface-mount device of claim 1, wherein the first pair of angled members is comprised of a first fastener comprised of a magnet, a clip, a tab, an angled tab, or a hook.

7. The box fan surface-mount device of claim 1, wherein the second pair of angled members is comprised of a second fastener comprised of a magnet, a clip, a tab, an angled tab, or a hook.

8. The box fan surface-mount device of claim 1, wherein the frame assembly is further comprised of a mounting structure.

9. The box fan surface-mount device of claim 1, wherein the first cradle assembly attaches to the first frame member via a first pivot point such that the first cradle assembly is repositionable relative to the first frame member.

10. The box fan surface-mount device of claim 1, wherein the second cradle assembly attaches to the second frame member via a second pivot point such that the second cradle assembly is repositionable relative to the second frame member.

11. The box fan surface-mount device of claim 1 further comprising a vibration-dampening element.

12. The box fan surface-mount device of claim 1 further comprising an anti-slip element.

13. A box fan surface-mount device comprising:
a frame assembly comprising a first frame member and a second frame member connected by a telescopic horizontal frame arm comprised of a locking member;
wherein the first frame member is comprised of a first vertical member and a first pair of horizontal members;
wherein the second frame member is comprised of a second vertical member and a second pair of horizontal members;
wherein the first frame member is comprised of a first cradle assembly configured to receive a box fan; and
further wherein the second frame member is comprised of a second cradle assembly configured to receive the box fan.

14. The box fan surface-mount device of claim 13, wherein the locking mechanism is comprised of a twist-lock collar, a detent pin, a threaded knob, a friction-based clamp, or a spring-loaded latch.

15. The box fan surface-mount device of claim 13, wherein the first cradle assembly attaches to the first frame member via a first pivot point such that the first cradle assembly is repositionable relative to the first frame member.

16. The box fan surface-mount device of claim 13, wherein the second cradle assembly attaches to the second frame member via a second pivot point such that the second cradle assembly is repositionable relative to the second frame member.

17. The box fan surface-mount device of claim 13, wherein the frame assembly is further comprised of a mounting structure comprised of a bracket, a flange, a plate, a groove, a channel, or a recess.

18. The box fan surface-mount device of claim 13 further comprising a vibration-dampening element.

19. The box fan surface-mount device of claim 13 further comprising an anti-slip element.

20. A method of using a box fan surface-mount device, the method comprising the following steps:
providing a box fan surface-mount device comprised of a first frame member, a second frame member, a horizontal frame arm connecting the first and second frame members, and a cradle assembly;
inserting the box fan into the cradle assembly such that the cradle assembly retains the box fan in position; and
adjusting a pivot point to reposition the cradle assembly to orient the box fan in a desired direction.
